(19) United States
(12) Patent Application Publication
(10) Pub. No.: US 2016/0335325 A1
(43) Pub. Date: Nov. 17, 2016

(54) METHODS AND SYSTEMS OF KNOWLEDGE RETRIEVAL FROM ONLINE CONVERSATIONS AND FOR FINDING RELEVANT CONTENT FOR ONLINE CONVERSATIONS

(71) Applicants: Krishna Kishore Dhara, Hyderabad (IN); Prakhar Gupta, Bangalore (IN); Anil Jwalanna, Cupertino, CA (US)

(72) Inventors: Krishna Kishore Dhara, Hyderabad (IN); Prakhar Gupta, Bangalore (IN); Anil Jwalanna, Cupertino, CA (US)

(21) Appl. No.: 14/710,590

(22) Filed: May 13, 2015

(51) Int. Cl. G06F 17/30; H04L 12/58

(52) U.S. Cl. CPC G06F 17/30539; H04L 51/046; H04L 51/12; H04L 51/16; G06F 17/3053; G06F 17/30551

(57) ABSTRACT

In one embodiment, a computer-implemented method of a retrieval from online conversations and for finding relevant content for online conversations can include the step of continuously associating a mined attributes to a conversation. The method can include the step of identifying a portion of a conversation based on the continuous association and the step of providing a retrieval mechanism for the portion of the conversation. A real-time recommendation for knowledge sharing across an enterprise or for a particular user as part of the conversation can be provided. Optionally, the conversation comprises a current conversation or an archived conversation.

### BACKGROUND

1. Field

This application relates generally to cloud computing, and more specifically to a system, method and apparatus for retrieval from online conversations and for finding relevant content for online conversations.

2. Related Art

Social networks can be used in enterprise for employees to exchange and/or discover knowledge ‘nuggets’. A knowledge nugget can be represented as an experience or documented as content. In one example, an employee can search for a successful customer RFP responses, content that includes a “to do” and “not to do” list, technical knowledge, etc. An employee may wish to solidify conversations based on topics. Here the challenge can be to isolate topics on conversations that are transient in nature. A topic of discussion may evolve as new feeds/posts come into the conversation. An employee may wish to track seemingly divergent discussions that may or may not converge. For example, in an archived or an ongoing conversation, isolate pans may converge or be identified as potentially converging or diverging. In a retrieved conversation, a method may be needed to identify and highlight converged parts and/or grey out diverged parts. This could help users to quickly retrieve relevant information. Based on the conversation, there could be content in a user's repository or an enterprise repository that could be shared in the conversation.

### BRIEF SUMMARY OF THE INVENTION

In one embodiment, a computer-implemented method of a retrieval from online conversations and for finding relevant content for online conversations can include the step of continuously associating mined attributes to a conversation. The method can include the step of identifying a portion of a conversation based on the continuous association and the step of providing a retrieval mechanism for the portion of the conversation. A real-time recommendation for knowledge sharing across an enterprise or for a particular user as part of the conversation can be provided. Optionally, the conversation comprises a current conversation or an archived conversation.

### BRIEF DESCRIPTION OF THE DRAWINGS

FIG. 1 illustrates an example process for retrieval from online conversations and for finding relevant content for online conversations, according some embodiments.

FIG. 2 illustrates an example process for continuous association of meta-data to incremental conversations, according to some embodiments.

FIG. 3 illustrates an example process for analyzing the association generated during process 200, according to some embodiments.

FIG. 4 illustrates an example process for retrieving and recommendation, according to some embodiments.

FIG. 5 depicts an exemplary computing system that can be configured to perform any one of the processes provided herein.

The Figures described above are a representative set, and are not an exhaustive with respect to embodying the invention.

### DESCRIPTION

Disclosed are a system, method, and article of manufacture for methods and systems of knowledge retrieval from online conversations and for finding relevant content for online conversations. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Content blocks can be structured or unstructured digital information of any size that includes text, pictures, video, audio, and other modalities. As an example, a document can be a content block or a section of a document with its structure and any multi-media information that is present.

Feature vector can be an n-dimensional vector of numerical features that represent some object.

Hierarchical feature vector can be an n-dimensional vector where each element is itself a feature vector representing a certain aspect of the object.

Information retrieval (IR) can include the science of searching for information in or as documents or databases.

Online social network can be a platform to build social networks or social relations among people who share interests, activities, backgrounds or real-life connections. A social network service can include a representation of each user (e.g. as a profile), the user's social links, various messaging services (e.g. instant messaging, updates, microblog posts, etc.) and/or a variety of additional services. Social network sites can be web-based services. Example online social networks can include, inter alia: Facebook®, LinkedIn®, Twitter®, etc.

Request for proposal (RFP) can be a solicitation, often made through a bidding process, by an agency or company interested in procurement of a commodity, service or valuable asset, to potential suppliers to submit business proposals.

Search engine can include an information retrieval system designed to help find information stored on a computer system.

Strong similarity measure can be similarity measures above a specified value. A similarity measure (and/or similarity function) can be a real-valued function that quantifies the similarity between two objects. Although no single definition of a similarity measure exists, usually similarity measures are in some sense the inverse of distance metrics: they take on large values for similar objects and either zero or a negative value for very dissimilar objects. In some examples, a cosine similarity can used as a similarity measure.

Strong dissimilarity measure can be a dissimilarity measure above a specified value (e.g. a metric that produces a higher value as corresponding values in two compared vectors X and Y become less dependent and/or less alike).

Text-based search can include techniques for searching a single computer-stored document or a collection in a full text database. Text-based search can include a full-text search and/or searches based on metadata (e.g. titles, abstracts, selected sections, or bibliographical references, etc.) and/or on parts of the original texts represented in databases. For example, a search engine can examine all of the words in every stored document as it tries to match search criteria (e.g. text specified by a user).

Additional example definitions are provided herein.

Example Processes

The current invention relates to the fields of content mining in online social networks and discovery of relevant content (e.g. enterprise) social networks. The nature of a conversation can be identified by incrementally looking at the changes in the conversation and finding relevant information snippets. The relevant information snippet can be posted as responses to online conversations (e.g. an email conversation, an instant messaging conversation, a text messaging conversation, microblog posts, online social network messages, any combination thereof, etc.). In some embodiments, mined attributes can be used to identify parts of a current or an archived conversation based on the continuous association. A retrieval mechanism can be provided for parts of a conversation. Additionally, a real-time recommendation for knowledge sharing across the enterprise or for a particular user can be provided as part of the conversation.

It is noted that searching for content can include two dimensions. One dimension can include determining if content is available for the employee to reuse. Another dimension is to search in their own repository for content relevant that could enhance the conversation or allows knowledge sharing that improves productivity in enterprises. In such scenarios, enterprises can provide an archival system that allows search capabilities for finding relevant prior conversations. An enterprise can also allow users to look at current conversations for knowledge or for contributing to the thread.

One example embodiment, can be focussed on enterprise social networks through applicable to consumer social networks. An enterprise social network can be used in enterprise for internal discussions. Via the enterprise social network, the enterprise employees exchange and/or discover knowledge ‘nuggets’. A knowledge nugget can be represented as an experience or documented as content.

In one example, an enterprise employee, such as a service engineer or a sales person, can look at their enterprise online networks to find out the “to do” and the “not to do” list. There are two aspects to finding this out. One aspect is to search a whole or a part of conversation to search and find content available for reuse. A second dimension can be to search in their own repository for content relevant that could enhance the conversation or allows knowledge sharing that improves productivity in the enterprise. For an effective retrieval or contribution, especially in large enterprises with active social conversations, the ability to search or find relevance to parts of a conversation is crucial. Similarly, enterprise employees can share technical knowledge or best practices.

Another example is sales people responding to request-for-proposal (RFP). Often these RFPs consist of customer requirement in the form of questions and sales people respond to them by looking at the content they or their colleagues in the enterprise have. A typical salesperson responds to many such closely related but not identical RFPs. Some of the RFP questions could be already responded in earlier RFPs and shared in a common repository or in a discussion, especially the responses that are successful and that are not. Such knowledge or access to such knowledge enables sales people to quickly and effectively respond to RFPs. The ability to search partial or whole conversations based on the questions and reuse content or access pointers to content from an online enterprise network or to contribute to such networks will improve the productivity of the sales teams in an enterprise.

Accordingly, the enterprise can provide the following. The enterprise can deploy an archival system. The archival system can provide search capabilities for finding relevant prior conversations. The archival system can enable users to look at current conversations for knowledge and/or for contributing to the current conversation. Additionally, the archival system can solidify conversations based on topics. This topic association tracks convergence of the conversation and associates topics to parts of conversation for effective retrieval of relevant part of a conversation. For example, various topics can be isolated for conversations that are transient in nature. It is noted that a topic of discussion may evolve as new feeds/posts come into the conversation. The archival system can track seemingly divergent discussions that may or may not converge. Convergence of a topic depends on features such as the relative entropy of key phrases over a contiguous period of time, elimination of spurious user comments within a time frame based on their reputation, the (enterprise hierarchical) role of the contributing user, etc.

In one example, in an archived or an ongoing conversation, the archival system can isolate and identify parts of said conversation that converged, are yet to converge and/or that are diverging. In this way, the archival system can identify and highlight converged parts of a conversation. The archival system can also grey out diverged parts. This information can then be presented via a computer interface to help users to quickly retrieve to relevant information. For example, based on a present conversation, there could be content in a user's repository or an enterprise repository that could be shared in the conversation. This information can be retrieved by the archival system and presented to the user for incorporation into the present conversation.

Various methods to mine conversations by isolating parts of conversations are now provided. These methods can retrieve relevant conversations and/or sub-parts of a conversation in an intuitive way. Additionally, these methods can offer an intuitive way for users to find the areas of discussion of interest both for consumption as well as sharing in a larger conversation. It is noted that conversations can be of a transient nature.

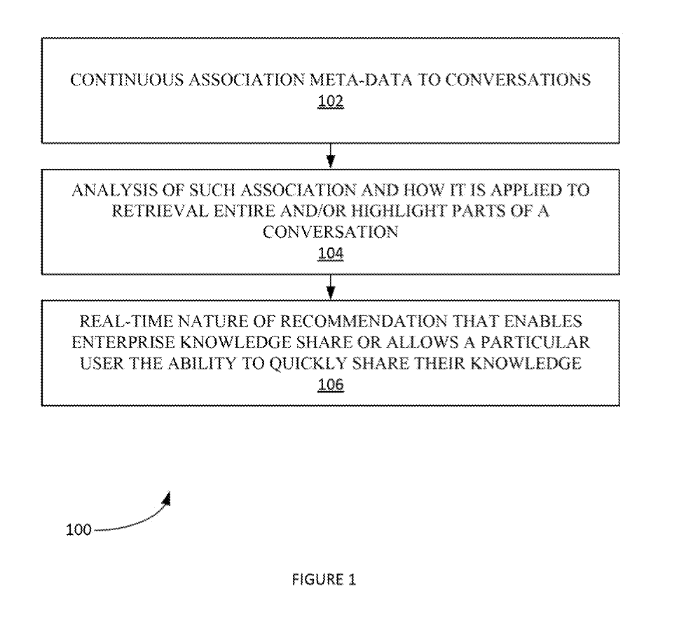

One embodiment can be broken into the three phases. FIG. 1 illustrates an example process 100 for retrieval from online conversations and for finding relevant content for online conversations, according some embodiments. In step 102, a first phase can be a continuous association meta-data to conversations. In step 104, a second phase can be an analysis of such association and how it is applied to retrieval entire and/or highlight parts of a conversation. In step 106, a third phase can be a real-time nature of recommendation that enables enterprise knowledge share or allows a particular user the ability to quickly share their knowledge. The various steps of process 100 are now discussed in greater detail.

Continuous Association of Meta-Data to Incremental Conversations

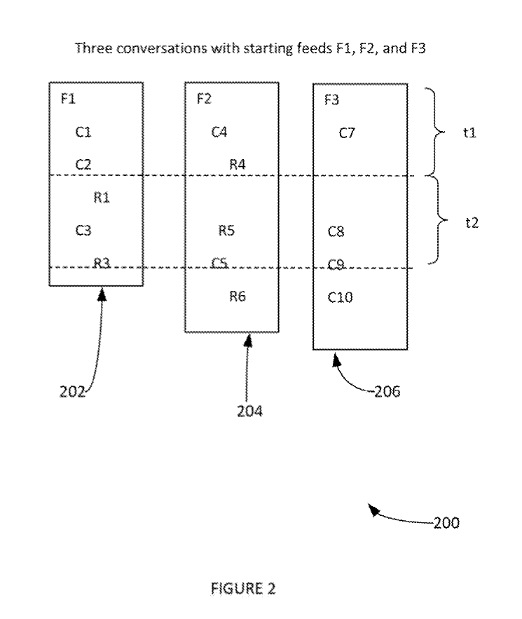

FIG. 2 illustrates an example process 200 for continuous association of meta-data to incremental conversations, according to some embodiments. For clarity, key words were mined as a representative meta-data. It is noted that the meta-data on conversations could contain other aspects (e.g., user's organization in an enterprise, hierarchy, etc.) Process 200 includes conversations 202-206 where F1, F2, F3, etc. are original feeds or posts; C1, C2, etc. are comments; and R1, R2, etc. are replies to comments. Let the time interval for incremental evaluation is t. That is, the bursts of messages that come in for analysis is t. Another way to think of this is that ‘t’ represents the desired granularity of analysing conversations.

FIG. 2 represents three sample conversations 202-206 that start with feeds F1, F2, and F3. The first conversation has an initial feed F1 and comments C1, C2 in the first time slice “t1”. The term “time slice” is used to indicate a period of time that can be configured depending on the activity of the social network. It could be as granular and real-time as looking at each update to a social network (without considering a constant time slice) or a defined period of time that may include more comments and responses. The corresponding content in a time slice is referred to as a “partial feed” and represented as PFi for time slice “i”. The first conversation in FIG. 2 has a reply R1 to C2 and a comment C3 with a reply R3 in time slice “t2”. The part of conversation with each time slice is represented as a partial feed, PF2 for the first conversation. In FIG. 2, PF1 for first conversation over time slice “t1” contains {F1, C2, C2}. The following steps can be performed for the continuous association of meta-data (keywords) with conversations. For each such partial feed, such as PF1, do the following. Process 200 generates a weighted key phrases <(k1, v1), (k2,v2), . . . > on, any posts, comments and replies in PF1<k1,v1> is the keyword, value pair. The key word, value pair may be calculated using standard IR techniques such as weighted term frequencies, inverse document frequencies, and other lexical and semantic techniques. These key word vectors are associated to PF1 and t1. Process 200 incrementally performs the steps for each time interval and associate the keyword vectors. One unique aspect is the incremental computation, where process 200 does not need to return and analyze the entire conversation. Another unique aspect in determining the keyword weight for a PF is to consider the contributor's reputation or enterprise hierarchy of the contributor with respect to other participants in driving the conversation. Based on this we can ignore or increase the weightage of a post, comment, or a reply in a PF.

One aspect of process 200 is the capture of other meta-data that is generated during subsequent time intervals such as t2, t3. This meta-data can be relative to previous time intervals such as t1, t2, respectively. For example, in the case of keyword vectors, with each new part of conversations the key phrase values and other parameters based on contributor change (e.g. because the new parts of the conversation may or may not use those words/phrases). Process 200 associates the change in values as a meta-data vector along with the keyword vector. With this step, Process 200 has an association that maps meta-data (keyword vector and change in keyword scores across this time interval and previous time interval) to conversation with a time-stamp.

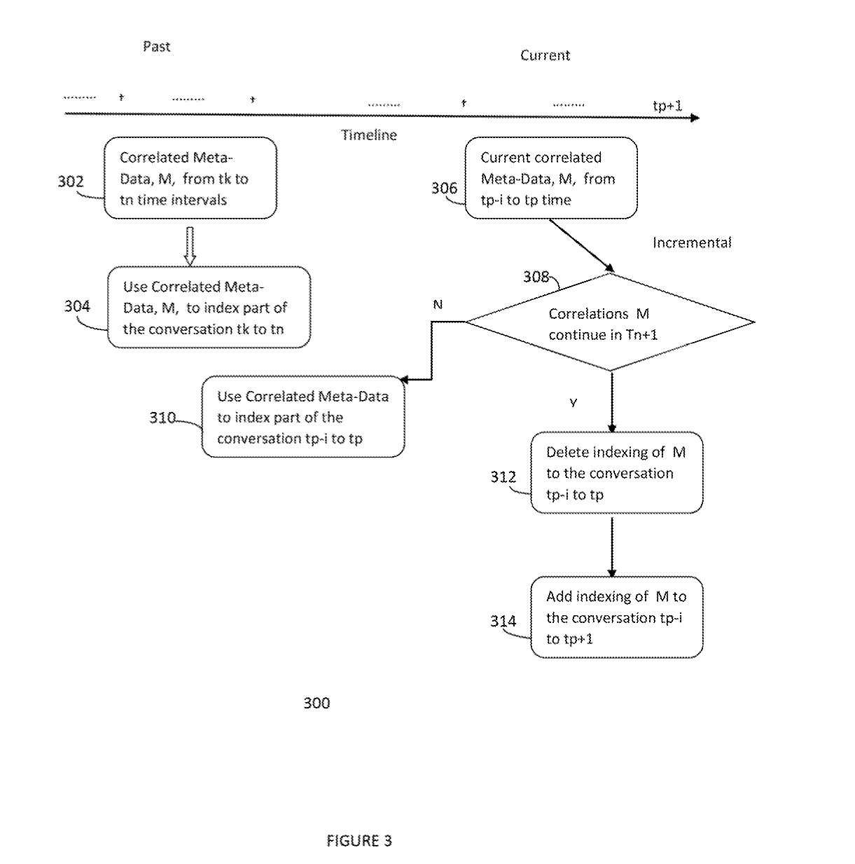

FIG. 3 illustrates an example process 300 for analyzing the association generated during process 200, according to some embodiments. Process 300 can analyse the following for each association. Process 300 can correlate k-set of keywords that moved up and down. Process 300 can track the correlated keywords with other meta data across a period of time intervals. If the duration and the correlation are above their respective threshold, process 300 can mark this period as converged on this set of keywords. If no such keywords are available then there is too much noise across time intervals and process 300 can index the individual parts with the default keyword vector. This can allow a retrieval system to pick this particular time interval if the meta-data (keyword vector) matches. The current interval correlations can be specifically matched to determine if they extend an existing matching converged interval. Converged intervals are index using the correlated meta-data.

Retrieving and Recommendation

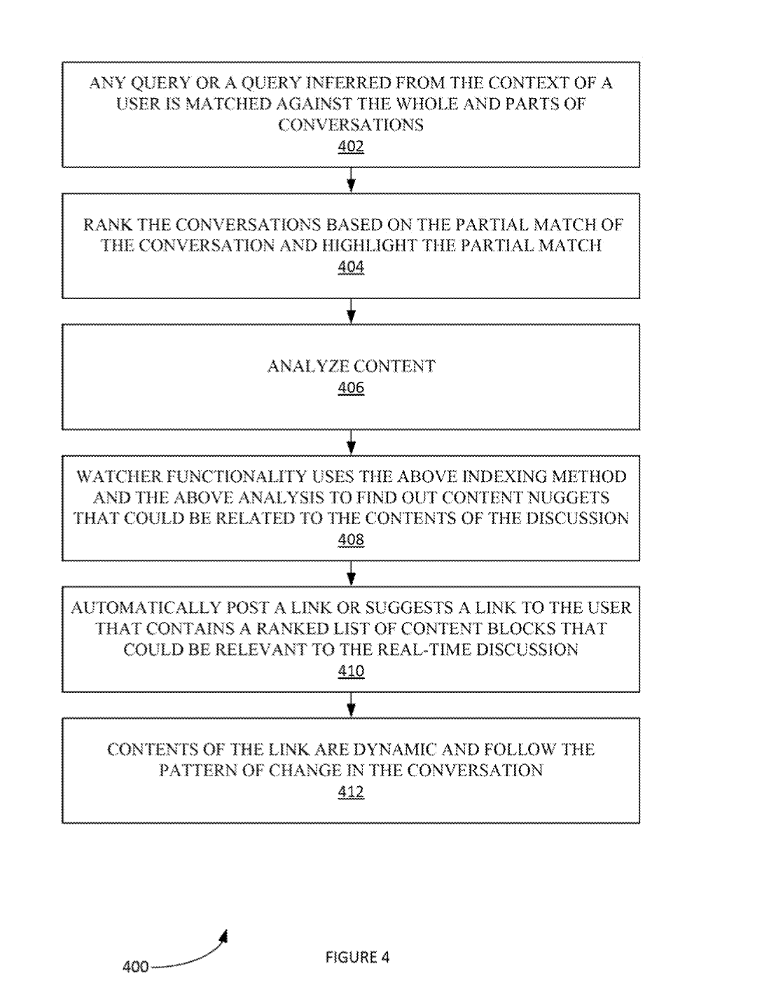

FIG. 4 illustrates an example process 400 for retrieving and recommendation, according to some embodiments. First, we discuss the retrieval part of the proposed system. In step 402 of process 400, any query or a query inferred from the context of a user is matched against the whole and parts of conversations. Unlike a traditional retrieval system, in our proposed system there could be a partial match that has a stronger score than a complete conversation match. That is a partial match in a conversation may have a strong match with what the user query is than an entire conversation that matches only parts of the query. Hence, step 404 ranks the conversations based on the partial match of the conversation and highlight the partial match if the user selects such a conversation based on the time interval meta-data from the (partial) conversation.

Second, step 406 proposes a system that acts on behalf of a user analysing content on their (e.g. could be per user, group, or entire enterprise) behalf. As new feeds/posts, comments, replies come in, in step 408, a watcher functionality uses the above indexing method and the above analysis to find out content nuggets that could be related to the contents of the discussion. In step 410, it automatically posts a link or suggests a link to the user that contains a ranked list of content blocks that could be relevant to the real-time discussion.

In step 412, the contents of the link are dynamic and follow the pattern of change in the conversation. The link posted in a conversation can give different results at different times based on how the conversation is proceeding. For example, if the query or conversation gets more specific or if the query gets more specific, the system proposed tracks those changes as described above and populates the contents of the link appropriately. This recommendation link is real-time and reacts to the current time interval.

Example Systems

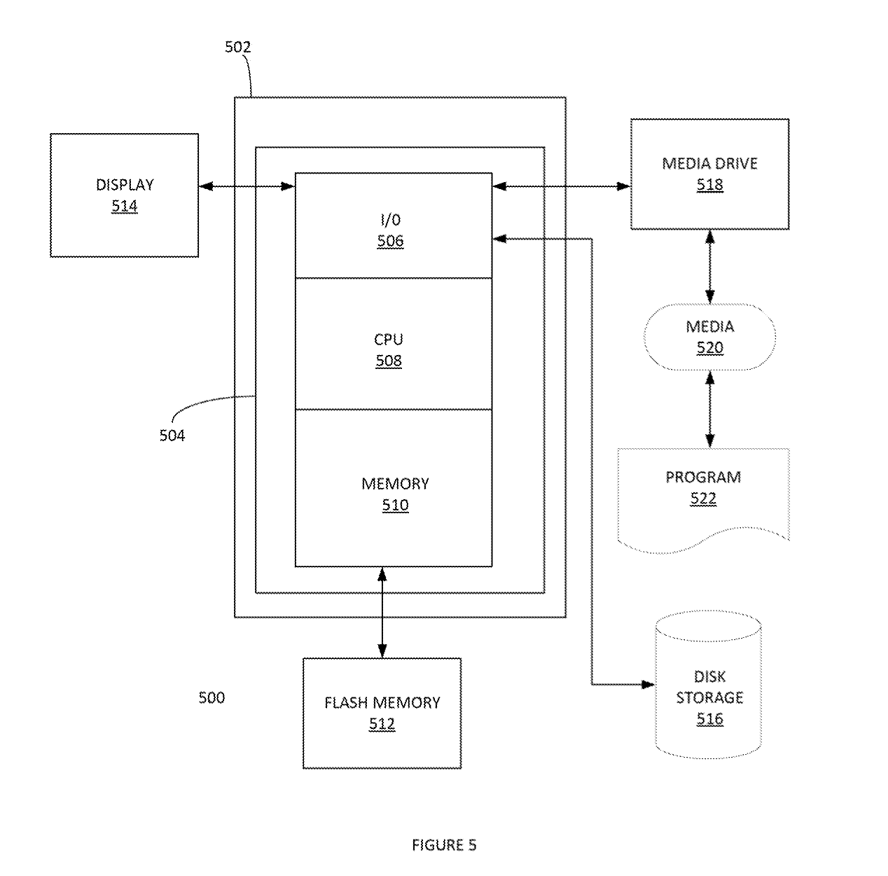

FIG. 5 depicts computing system 500 with a number of components that may be used to perform any of the processes described herein. The main system 502 includes a motherboard 508 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method of a retrieval from online conversations and for finding relevant content for online conversations comprising:
continuously associating a mined attributes to a conversation;
identifying a portion of a conversation based on the continuous association;
providing a retrieval mechanism for the portion of the conversation;
providing a real-time recommendation for knowledge sharing across an enterprise or for a particular user as part of the conversation.

2. The method of claim 1, wherein the conversation comprises a current conversation.

3. The method of claim 1, wherein the conversation comprises an archived conversation.

4. The method of claim 1, wherein the step of continuously associating a mined attributes to the conversation further comprises:
using a mined key-word as a representative meta-data.

5. The method of claim 4, wherein the step of continuously associating a mined attributes to the conversation further comprises:
determining a time interval of the conversation for evaluation.

6. The method of claim 5, wherein the step of continuously associating a mined attributes to the conversation further comprises:
generating one or more weighted key phrase on an original post of a conversation feed of the conversation;

7. The method of claim 6, wherein the step of continuously associating a mined attributes to the conversation further comprises:
generating a keyword-value pair and representing said key-word value pair as a keyword-value pair vector.

8. The method of claim 7, wherein the step of continuously associating a mined attributes to the conversation further comprises:
associating the keyword-value pair vector a partial feed and a time slice.

9. The method of claim 8 further comprising:
providing an association that maps a meta-data to a conversation with a time-stamp.

10. The method of claim 9, wherein the meta-data comprises a keyword vector and a change in one or more keyword scores across the time interval and a previous time interval.

11. The method of claim 10 further comprising:
automatically posting a hyperlink a user application that includes a ranked list of content blocks that are relevant to the real-time discussion.

12. A computerized system of a retrieval from online conversations and for finding relevant content for online conversations comprising:
a processor configured to execute instructions;
a memory containing instructions when executed on the processor, causes the processor to perform operations that:
continuously associate a mined attributes to a conversation;
identify a portion of a conversation based on the continuous association;
provide a retrieval mechanism for the portion of the conversation:
provide a real-time recommendation for knowledge sharing across an enterprise or for a particular user as part of the conversation.

13. The system of claim 12, wherein the conversation comprises a current conversation.

14. The system of claim 12, wherein the conversation comprises an archived conversation.

15. The system of claim 12, wherein memory containing instructions when executed on the processor, causes the processor to perform operations that:
use a mined key-word as a representative meta-data;
determine a time interval of the conversation for evaluation;
generate one or more weighted key phrase on an original post of a conversation feed of the conversation;
generate a keyword-value pair and representing said key-word value pair as a keyword-value pair vector; and
associate the keyword-value pair vector a partial feed and a time slice.

16. The system of claim 15, wherein memory containing instructions when executed on the processor, causes the processor to perform operations that:
providing an association that maps a meta-data to a conversation with a time-stamp.

17. The system of claim 16, wherein the meta-data comprises a keyword vector and a change in one or more keyword scores across the time interval and a previous time interval.

18. The system of claim of claim 17, wherein memory containing instructions when executed on the processor, causes the processor to perform operations that:
automatically posting a hyperlink a user application that includes a ranked list of content blocks that are relevant to the real-time discussion.

19. The system of claim 18, wherein a convergence of a topic is based on a relative entropy of a key phrase over a contiguous period of time and an elimination of a spurious user comment within a time frame based on a user's reputation and an enterprise hierarchical role of a contributing user.
